(19) United States
(12) Patent Application Publication
(10) Pub. No.: US 2009/0316329 A1
(43) Pub. Date: Dec. 24, 2009

(54) CHIP COMPONENT AND METHOD FOR PRODUCING THE SAME AND COMPONENT BUILT-IN MODULE AND METHOD FOR PRODUCING THE SAME

(75) Inventor: Masato Nomura, Moriyama-shi (JP)

Correspondence Address: DICKSTEIN SHAPIRO LLP, 1633 Broadway, NEW YORK, NY, 10019, US

(73) Assignee: Murata Manufacturing Co., Ltd., Nagaokakyo-shi (JP)

(21) Appl. No.: 12/487,943

(22) Filed: Jun. 19, 2009

(30) Foreign Application Priority Data
Jun. 19, 2008 (JP) 2008-160239

(51) Int. Cl. H01G 4/005

(52) U.S. Cl. 361/301.1; 29/25.41

(57) ABSTRACT

A chip component having external electrodes that allow both connection by an interlayer connection conductor and connection by soldering and a component built-in module containing the chip component therein are produced and provided. A metal of electrode parts on at least one principal surface of the external electrodes at the ends of the chip component is different from a metal of electrode parts at the remaining portion of the external electrodes. With such a structure, both a metal suitable for connection to an interlayer connection conductor, such as a via hole conductor or a through hole conductor of the component built-in module and, a metal suitable for soldering can be used for the external electrodes. Thus, the component built-in module can be reduced in the height and size.

### BACKGROUND OF THE INVENTION

1. Field of the Invention

The present invention relates to a chip component to be built into (embedded) an insulating layer of a component built-in module and a method for producing the same, and a component built-in module containing the chip component in the insulating layer and a method for producing the same. More specifically, the present invention relates to improvement of external electrodes of the chip component and improvement of the component built-in module with the improvement of the external electrodes of the chip component.

2. Description of the Related Art

Hitherto, various component built-in modules have contained various chip components, such as a ceramic capacitor or a resistor, in an insulating layer. In this case, the chip component is provided with external electrodes at the right and left ends, and the external electrodes are electrically connected to an in-plane conductor (pattern electrode or the like) on the top or bottom surface of the insulating layer through a certain connection conductor.

Specifically, when the connection conductor is an interlayer connection conductor, such as a via hole conductor or a through hole conductor, an external electrode of a chip component in a former component built-in module 100 is structured as shown in FIG. 13. FIG. 13 is an enlarged cross-sectional view showing the end of a ceramic capacitor 110, which is an example of the chip component. For example, the ceramic capacitor 110 is built into an insulating layer (insulating resin layer) 270 on a printed circuit 220. The external electrode (external electrode layer) 160 of the ceramic capacitor 110 is connected to a conductor pattern (in-plane conductor) 280A on the top surface of the insulating layer 270 through an interlayer connection conductor (interlayer connection portion) 330, such as a via hole conductor or a through hole conductor. The ceramic capacitor 110 is adhered to the printed circuit 220, and then molded by the insulating layer (insulating resin layer) 270. An interlayer connection hole is formed in the insulating layer 270 by subjecting the insulating layer 270 to laser irradiation from above. By, for example, plating the interlayer connection hole, the top surface of the external electrode 160 of the ceramic capacitor 110 is bonded to the bottom surface of the interlayer connection conductor 330, whereby the external electrode 160 of the ceramic capacitor 110 is electrically connected to the conductor pattern 280A on the top surface of the insulating-layer 270 through the interlayer connection conductor 330 (e.g., Patent Document 1). Also when the chip component to be built into the insulating layer 270 is a component other than the ceramic capacitor 110, an external electrode part at the end is structured in substantially the same manner as that of FIG. 13.

### [Patent Document 1] Japanese Unexamined Patent Application Publication No. 2003-309373 (Paragraphs [0047] to [0066] and FIGS. 1, 2, 3, etc.)

As is clear from FIG. 13, in the case of the former component built-in module 100 of FIG. 13, the ceramic capacitor 110 serving as the chip component is connected only to the conductor pattern 280A on the top surface of the insulating layer 270 through the interlayer connection conductor 330 and is not connected to a circuit pattern (in-plane conductor) 240A on the bottom surface of the insulating layer 270.

Therefore, it is necessary to further provide, in the insulating layer 270, an interlayer connection conductor, such as a via hole conductor or a through hole conductor, through which the conductor pattern 280A on the top surface and the circuit pattern 240A on the bottom surface are connected to each other. This causes problems such that a reduction in the height and size of the component built-in module 100 is hindered, the line length between the top and bottom surfaces of the insulating layer 270 becomes large, resulting in an increase in electrical loss, and the number of the interlayer connection conductors in the insulating layer 270 increases thereby increasing wiring density and causing mutual interference between the interlayer connection conductors. The diameter of the via hole conductor or the through hole conductor of the interlayer connection conductor 330 increases with an increase in the thickness of the insulating layer 270. Therefore, in the component built-in module 100 or the like, particularly the interlayer connection conductor is bulky, which hinders size reduction.

In the component built-in module 100, for example, in place of providing the interlayer connection conductor through which the conductor pattern 280A on the top surface of the insulating layer 270 and the circuit pattern 240A on the bottom surface are connected to each other, it may be acceptable that the bottom surface of the external electrode 160 is connected to the circuit pattern 240A and the conductor pattern 280A on the top surface of the insulating layer 270 and the circuit pattern 240A on the bottom surface are connected utilizing the external electrode 160 of the ceramic capacitor 110, thereby reducing the size of the component built-in module 100. However, the manner in which the bottom surface of the external electrode 160 is connected to the circuit pattern 240A is problematic.

The via hole conductor and the through hole conductor of the interlayer connection conductor 330 are formed by forming a hole (interlayer connection hole) in the insulating layer 270 by irradiating the external electrode 160 with a laser from above the insulating layer 270, and then, for example, plating the hole. In this case, when the external electrode 160 is formed of tin or nickel, the reflexibility of the external electrode 160 with respect to the laser is poor and the ceramic capacitor 110 is damaged due to strong laser irradiation. In order to avoid the above, the external electrode 160 is formed of copper that does not have such disadvantages.

In contrast, the external electrode 160 formed of copper is not suitable for soldering due to ease of surface oxidation. Therefore, when the external electrode 160 is formed of copper, the external electrode 160 and the circuit pattern 240A cannot be connected to each other by soldering.

### SUMMARY OF THE INVENTION

Accordingly, it is an object of the present invention to provide an innovative chip component provided with external electrodes that allow both connection by an interlayer connection conductor and connection by soldering and a method for producing the same, and further to provide a novel component built-in module containing the chip component in the insulating layer and a method for producing the same.

In order to achieve the objects, a chip component according to preferred embodiments of the present invention is a chip component that has external electrodes at the ends and is built into an insulating layer of a component built-in module, in which at least one portion of one principal surface of the insulating layer in the external electrodes is formed of a metal different from that forming the remaining portion of the external electrodes (First aspect).

Preferably, the at least one portion of the one principal surface of the insulating layer in the external electrodes is composed of copper and at least the front surface of the remaining portion of the external electrodes is composed of tin or nickel (Second aspect).

A method for producing a chip component according to preferred embodiments of the present invention includes, in a method for producing a chip component that has external electrodes at the ends and is built into an insulating layer of a component built-in module, forming copper electrode parts on at least one portion of one principal surface of the insulating layer at the ends; and forming electrode parts whose front surface at least is composed of tin or nickel on the remaining portion of the ends and forming the external electrodes by the copper electrode parts and the tin or nickel electrode parts (Third aspect).

A method for producing a chip component according to preferred embodiments of the present invention includes, in a method for producing a chip component that has external electrodes at the ends and is built into an insulating layer of a component built-in module, preparing a substantially substrate-like chip component assembly that is divided into a plurality of chip component regions and forming copper electrode parts at the ends of each chip component region on both surfaces of the chip component assembly; forming grooves along the boundary between the ends of each chip component region; charging the grooves with a copper paste, and bonding the copper electrode parts of both surfaces of each chip component region with the copper paste; cutting and dividing the chip component assembly in which the grooves are charged with the copper paste into each chip component region; and plating a portion other than at least one portion of the top surface or the bottom surface at the ends of each divided chip component region with tin or nickel to form the external electrodes (Fourth aspect).

A component built-in module according to preferred embodiments of the present invention is a component built-in module containing a chip component having external electrodes at the ends in an insulating layer, in which, the chip component has at least one portion of one principal surface of the insulating layer in the external electrodes being formed of a metal different from a metal of the remaining portion and having an interlayer connection conductor through which the at least one portion of the one principal surface of the insulating layer in the external electrodes is connected to an in-plane conductor on the one principal surface of the insulating layer and an electrically conductive bonding material that is present between the other principal surface of the insulating layer in the external electrodes and an in-plane conductor on the other principal surface of the insulating layer to bond the other principal surface of the insulating layer in the external electrodes to the in-plane conductor on the other principal surface of the insulating layer (Fifth aspect).

Preferably, the at least one portion of the one principal surface of the insulating layer in the external electrodes is composed of copper and the interlayer connection conductor is formed by imparting electrical conductivity to a hole formed by irradiating the insulating layer with a laser (Sixth aspect). Preferably, at least the front surface of the remaining portion of the external electrodes is composed of tin or nickel and the electrically conductive bonding material is a solder (Seventh aspect).

A method for producing a component built-in module according to preferred embodiments of the present invention is a method for producing a component built-in module in which a chip component having external electrodes at the ends is built into an insulating layer, the chip component having at least one portion of one principal surface of the insulating layer in the external electrodes being formed of a metal different from that of the remaining portion, and the method includes: connecting the at least one portion of the one principal surface of the insulating layer in the external electrodes to an in-plane conductor on the one principal surface of the insulating layer through an interlayer connection conductor; and bonding the other principal surface of the insulating layer in the external electrodes to an in-plane conductor on the other principal surface of the insulating layer with an electrically conductive bonding material (Eighth aspect).

A method for producing a component built-in module according to preferred embodiments of the present invention is a method for producing a component built-in module containing a chip component having external electrodes at the ends in an insulating layer, the chip component having at least one portion of one principal surface of the insulating layer in the external electrodes being formed of a metal different from that of the remaining portion, and the method includes: preparing a base having an in-plane conductor formed on the top surface and the chip component and bonding the other principal surface of the insulating layer in the external electrodes to the in-plane conductor of the base with an electrically conductive bonding material; embedding the chip component in the insulating layer to be built therein while the other principal surface of the insulating layer in the external electrodes is being bonded to the in-plane conductor of the base; and forming, in the insulating layer, an interlayer connection conductor to be connected to the one portion of the principal surface of the insulating layer in the external electrodes (Ninth aspect).

Preferably, in the remaining portion of the external electrodes, at least the front surface to be bonded to the electrically conductive bonding material is formed of tin or nickel and the electrically conductive bonding material is a solder (Tenth aspect). Preferably, the at least one portion of the one principal surface of the insulating layer in the external electrodes is composed of copper and the interlayer connection conductor is formed by imparting electrical conductivity to a hole formed by irradiating the insulating layer with a laser (Eleventh aspect).

According to the invention of the first aspect, since the metal of the one portion of the one principal surface of the external electrodes is different from the metal of the remaining portion, a metal suitable for connection with the interlayer connection conductor, such as the via hole conductor or the through hole conductor, or a metal suitable for soldering can be used for the metal of the one portion of the principal surface and a metal suitable for soldering or a metal suitable for connection to the interlayer connection conductor can be used for the metal of the remaining portion. Thus, an innovative chip component can be provided that is built into the insulating layer of the component built-in module and in which both connection by the interlayer connection conductor and connection by soldering are favorably applied for connection of the external electrodes.

According to the invention of the second aspect, since one portion of the one principal surface of the insulating layer in the external electrodes is composed of copper, the interlayer connection conductor can be formed at the one portion by favorably laser reflection without injury to the external electrodes and the one principal surface of the insulating layer in the external electrodes can be favorable connected to the interlayer connection conductor. Moreover, since at least the surface the remaining portion of the external electrodes is composed of tin or nickel suitable for soldering, the other principal surface of the insulating layer in the external electrodes can be favorably soldered.

According to the invention of the third aspect, a method for producing the chip component of the second aspect can be provided.

According to the invention of the fourth aspect, in the substantially substrate-like chip component assembly, copper electrode parts are formed at the ends of both surfaces of each chip component region.

Then, grooves are formed along the end surface of each chip component region of the chip component assembly. When the grooves are charged with a copper paste, the copper electrode parts of both surfaces of each chip component region are connected to each other through the copper paste, whereby the entire ends of each chip component region are formed into the copper electrode parts.

The chip component assembly is cut and divided into each chip component region to form pieces. At the ends of each divided chip component region, the external electrodes in which at least one portion of the top surface or the bottom surface is composed of copper and at least the front surface of the remaining portion is composed of tin or nickel are formed by plating, with tin or nickel, a portion other than at least one portion of the top surface or the bottom surface of each of the copper electrode parts of the ends.

Thus, a chip component similar to that of the fourth aspect can be easily mass-produced from the chip component assembly.

According to the invention of the fifth aspect, the chip component having at least one portion of one principal surface of the insulating layer in the external electrodes at the ends being formed with metal different from the metal of the remaining portion is built into the insulating layer. Then, the at least one portion of the one principal surface of the insulating layer in the external electrodes is connected to the in-plane conductor of the one principal surface of the insulating layer through the interlayer connection conductor, and the other principal surface of the insulating layer in the external electrodes is bonded to the in-plane conductor of the other principal surface of the insulating layer with the electrically conductive bonding material, whereby a component built-in module is formed.

In this case, the in-plane conductor on the one principal surface of the insulating layer of the component built-in module and the in-plane conductor on the other principal surface of the insulating layer are connected to each other through the external electrodes of the chip component. Thus, it is not necessary to provide, to the insulating layer, another interlayer connection conductor through which the in-plane conductor on the one principal surface and the in-plane conductor on the other principal surface are connected to each other.

With respect to the external electrodes of the chip component, the one principal surface of the insulating layer is connected to the in-plane conductor on the one principal surface of the insulating layer through the interlayer connection conductor and the other principal surface of the insulating layer is bonded to the in-plane conductor on the other principal surface of the insulating layer with the electrically conductive bonding material. Thus, particularly the connection between the external electrodes of the chip component and the other principal surface of the insulating layer is carried out using a thin electrically conductive bonding material, such as a solder, in place of connecting through a bulky interlayer connection conductor.

Thus, the reduction in the height and size of this kind of component built-in module can be achieved. Furthermore, the line length between the top and bottom surfaces of the insulating layer of the component built-in module does not become long, electrical loss does not increase, the number of the interlayer connection conductors in the insulating layer does not increase, and the wiring density does not increase. Thus, the component built-in module does not suffer from mutual interference or the like between the interlayer connection conductors.

The invention of the sixth aspect can provide a more excellent component built-in module in which a portion to be connected to the interlayer connection conductor of each external electrode of the chip component built in the insulating layer is composed of copper that performs favorable laser reflection and the interlayer connection conductor, such as the via hole conductor or the through hole conductor, can be formed by irradiating the insulating layer with a laser without injury or the like to the chip component and which demonstrates the effects of the fifth aspect.

According to the invention of the seventh aspect, since at least the front surface of the remaining portion of the external electrodes of the chip component to be built into the insulating layer is composed of tin or nickel suitable for soldering and the external electrodes are bonded to the other principal surface of the insulating layer with the solder serving as the electrically conductive bonding material, a component built-in module whose height and size are favorably further reduced can be provided.

According to the invention of the eighth aspect, the component built-in module can be produced by providing the chip component of the present invention in the insulating layer, connecting the at least one portion of the one principal surface of the insulating layer in the external electrodes to the in-plane conductor on the one principal surface of the insulating layer through the interlayer connection conductor, and bonding the other principal surface of the insulating layer in the external electrodes to the in-plane conductor on the other principal surface of the insulating layer with the electrically conductive bonding material in such a manner as not to be bulky.

According to the invention of the ninth aspect, the component built-in module can be produced in such a manner as to have a more specific structure by bonding the other principal surface of the insulating layer of the component built-in module in the chip component to the in-plane conductor on the top surface of the substrate with the electrically conductive bonding material, providing the chip component in the insulating layer in the state, and connecting the external electrodes of the chip component to a portion of the one principal surface of the insulating layer through the interlayer connection conductor in the insulating layer.

According to the invention of the tenth aspect, a component built-in module in which the electrically conductive bonding material of the base is a solder can be produced by favorably soldering tin or nickel on the other principal surface of the insulating layer in the external electrodes.

According to the invention of the eleventh aspect, a component built-in module in which, in the external electrodes at the ends of the chip component, the at least one portion of the one principal surface of the insulating layer is composed of copper with favorable laser reflection can be produced by favorably forming the via hole conductor or the through hole conductor serving as the interlayer connection conductor by laser irradiation without injury to the external electrodes.

Other features, elements, characteristics and advantages of the present invention will become more apparent from the following detailed description of preferred embodiments of the present invention (with reference to the attached drawings).

### BRIEF DESCRIPTION OF THE DRAWINGS

FIG. 1 is an enlarged perspective view of a chip component according to a first embodiment;

FIG. 2 is a cross sectional view schematically illustrating connection of electrodes when the chip component of FIG. 1 is built into a component built-in module;

FIG. 3 is an enlarged perspective view of a chip component of a second embodiment;

FIG. 4 is a view illustrating production processes of a chip component of a third embodiment;

FIG. 5 is a view illustrating some processes of production processes of a chip component of a fourth embodiment;

FIG. 6 is a view illustrating other processes of the production processes of the chip component of the fourth embodiment;

FIG. 7 is a view illustrating sill other processes of the production processes of the chip component of the fourth embodiment;

FIG. 8A and FIG. 8B are an enlarged plan view and an enlarged cross sectional front view, respectively, illustrating divided chip component regions of the fourth embodiment;

FIG. 9 is a cross sectional view of a component built-in module of a fifth embodiment;

FIG. 10 is a view illustrating some processes of production process of a component built-in module of a sixth embodiment;

FIG. 11 is a view illustrating other processes of the production processes of the component built-in module of the sixth embodiment;

FIG. 12 is a view illustrating a modified example of the production process of the component built-in module of the sixth embodiment; and

FIG. 13 is a cross sectional view illustrating a former example.

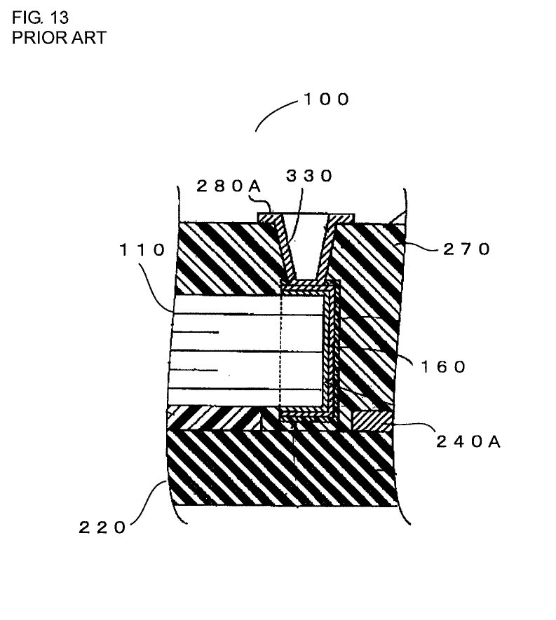

### DESCRIPTION OF THE PREFERRED EMBODIMENTS

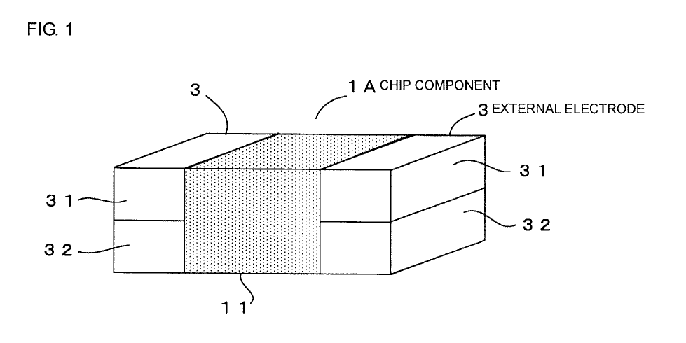

Next, in order to describe the present invention in more detail, embodiments will be described in detail with reference to FIGS. 1 to 12. In each figure, oblique lines indicating sectional surfaces are suitably omitted. The components designated by the same reference numerals in each figure are the same components or corresponding components.

### <Chip Component and a Method for Producing the Same>

Embodiments of a chip component of the present invention and a method for producing the same will be described with reference to FIGS. 1 to 8.

### First Embodiment

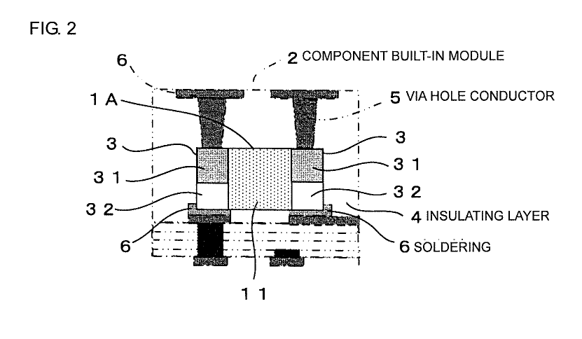

A chip component 1A according to a first embodiment corresponding to Aspects 1 and 2 will be described with reference to FIGS. 1 and 2. FIG. 1 is an enlarged perspective view of the chip component 1A and FIG. 2 is a cross sectional view schematically illustrating connection of electrodes when the chip component 1A is built into a component built-in module 2.

In the same manner as in the related art, the chip component 1A of this embodiment shown in FIG. 1 is provided with external electrodes 3 at the right and left ends of a minute chip component element assembly 11, such as a ceramic capacitor or a resistor and is built into an insulating layer 4 of the component built-in module 2 as shown in FIG. 2.

The chip component 1A is different from that of the related art in that the external electrodes 3 are constituted by two different kinds of electrode parts 31 and 32, i.e., an electrode part 31 on a principal surface (the top surface in this embodiment) of the insulating layer 4 and an electrode part 32 on the other principal surface (the bottom surface in this embodiment) of the insulating layer 4.

In this embodiment, the electrode part 31 is composed of copper (Cu) suitable for forming a hole of a via hole conductor 5 serving as an interlayer connection conductor by irradiating the insulating layer 4 of the component built-in module 2 with a laser. The electrode part 32 is composed of tin (Sn) or nickel (Ni) suitable for bonding with a solder 6 suitable for reducing the height.

Therefore, in this embodiment, an innovative chip component 1A can be provided in which the metal of the electrode part 31 on one principal surface of the component built-in module and the metal of the remaining electrode part 32 in each external electrode 3 are different from each other, and thus both connection through the via hole conductor 5 and connection with the solder 6 are favorably applied for connection of the external electrodes 3.

### Second Embodiment

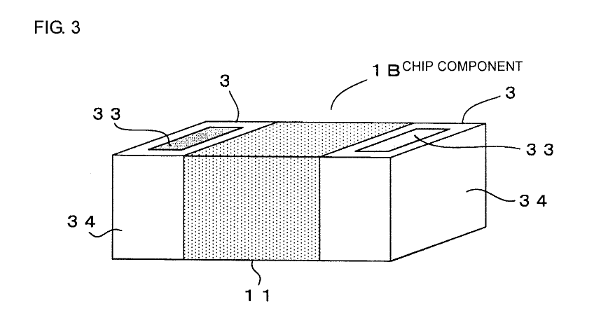

A chip component 1B according to a second embodiment corresponding to Aspects 1 and 2 will be described with reference to FIG. 3. FIG. 3 is an enlarged perspective view of the chip component 1B.

The chip component 1B according to this embodiment shown in FIG. 3 is different from the chip component 1A according to the first embodiment in that, in the external electrodes 3 at the right and left ends, only the central portion of the one principal surface (top surface) of the insulating layer 4 is a copper electrode part 33 and the remaining portion including the other principal surface (bottom surface) of an insulating layer 4 is a tin or nickel electrode part 34.

Also when the chip component 1B of this embodiment, in place of the chip component 1A, is built into the component built-in module 2 of FIG. 2, the central portion on the one principal surface of the insulating layer 4 in the external electrodes 3 is composed of copper suitable for forming the hole, such as the via hole conductor 5 and the other principal surface of the insulating layer 4 is composed of tin or nickel suitable for connection with the solder 6. Thus, both connection through the via hole conductor 5 and connection with the solder 6 are favorably applied for connection of the external electrodes 3.

In the electrode parts 32 and 34 connected with the solder 6, at least the front surface may be tin or nickel suitable for soldering and, for example, may be a two-layered metal of tin or nickel and copper. Depending on the electrode connection structure of the component built-in module 2, in the chip components 1A and 1B of both the above-described embodiments, the electrode parts 31 and 33 may be tin or nickel and the electrode parts 32 and 34 may be copper, and the combination of the metal of the electrode part 31 or 33 and the metal of the electrode part 32 or 34 is different from the combination of copper and tin or nickel.

### Third Embodiment

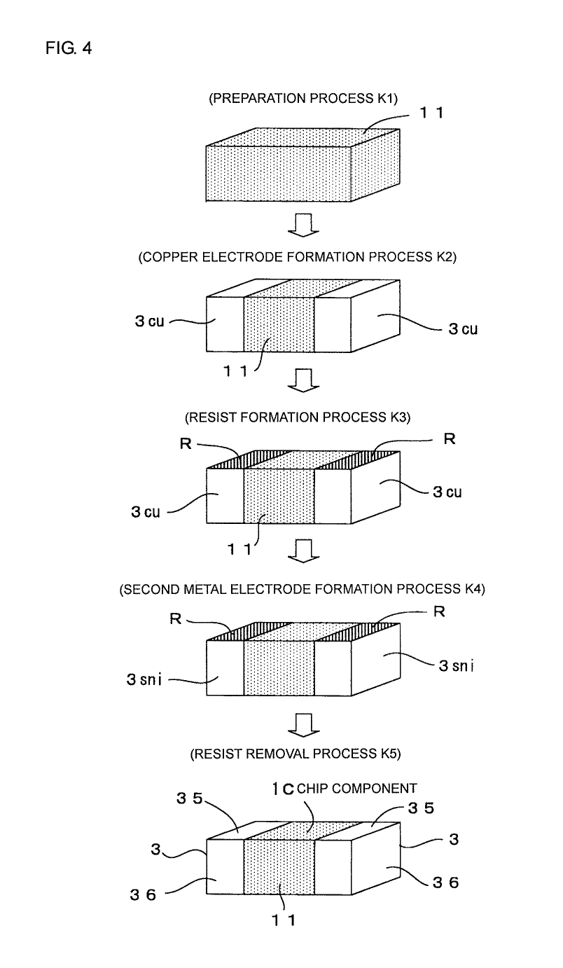

A third embodiment corresponding to Aspect 3, i.e., an example of a method for producing the chip component according to preferred embodiments of the invention, will be described with reference to FIG. 4 illustrating production processes.

A chip component 1C produced by this embodiment has a shape in which the electrode part 33 of the chip component 1B in FIG. 3 is extended over the surface. In the external electrodes 3 at the right and left ends thereof, one surface of the principal surface (top surface) of the insulating layer 4 of FIG. 2 is the copper electrode part 35 and the remaining portion is the tin or nickel electrode part 36, for example.

In the production method of this embodiment, a chip component element assembly 11 is prepared first by a preparation process K1 of FIG. 4. Next, copper electrodes 3Cu are formed over the entire surfaces of the right and left ends of the chip component element assembly 11 by printing, plating, or the like by a copper electrode formation process K2. Furthermore, a resist film R is formed on the top surface of the copper electrode 3Cu by a resist formation process K3. Next, a portion of the copper electrode 3Cu that is not covered with the resist film R is plated with a tin or nickel electrode 3sni by a second metal electrode formation process K4. In this case, since the copper electrode 3Cu is formed on a base of the electrode 3sni, plating or the like can be favorably performed. Then, the resist film R is removed by a resist removal process K5, thereby producing a chip component 1C.

In the chip component 1C thus produced, the top surface of the external electrodes 3 is the copper electrode part 35 formed of the copper electrode 3Cu and the remaining portion of the external electrode 3 is the electrode part 36 formed of a two-layered metal in which the front surface is the tin or nickel electrode 3sni and the rear surface is the copper electrode 3Cu. The chip component 1C thus produced demonstrates the same effects as those of the chip components 1A and 1B of the first and second embodiments. The processes K2 and K4 correspond to two processes of Aspect 3. It is a matter of course that the chip components 1A and 1B can be similarly produced.

A chip component similar to the chip component 1C also can be produced by providing a tin electrode formation process in place of the copper electrode formation process K2 of FIG. 4, forming tin electrodes on the entire surface of the right and left ends of the chip component element assembly 11, forming the resist film R in a portion other than the top surface of the right and left ends of the chip component element assembly 11 by the following resist formation process K3, and forming the copper electrodes on the top surface of the right and left ends of the chip component element assembly 11 by plating or the like the second metal electrode formation process K4.

### Fourth Embodiment

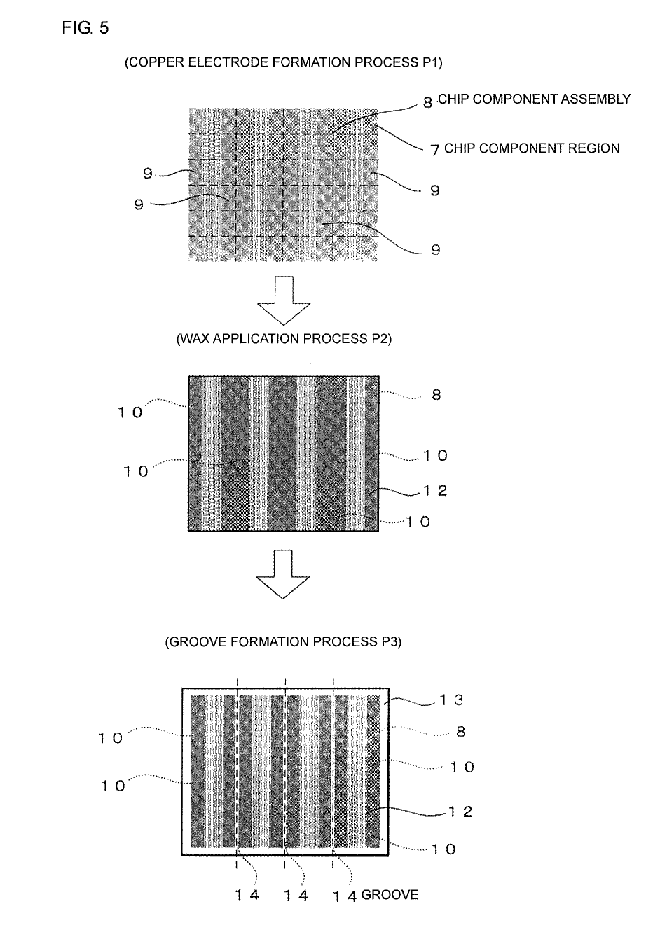

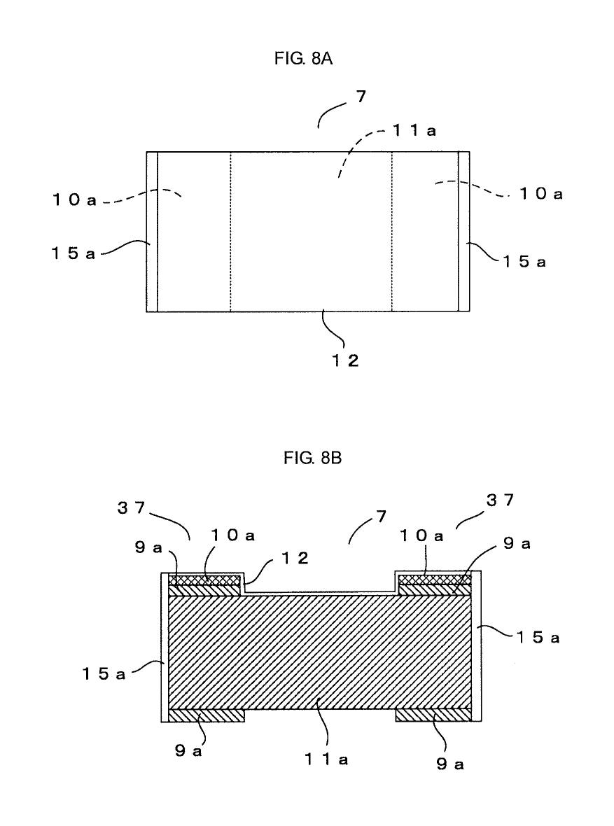

A fourth embodiment corresponding to the fourth aspect, i.e., another example of the method for producing the chip component according to preferred embodiments of the invention, will be described with reference to FIGS. 5 to 7 illustrating the production processes and FIG. 8A and FIG. 8B illustrating an enlarged plan view and an enlarged cross section front view, respectively, of the chip component region.

In this embodiment, in order to mass-produce a chip component 1D similar to the chip component 1C of the third embodiment, a substantially substrate-like chip component assembly 8 that is divided into a plurality of chip component regions 7 indicated by the dashed lines by cutting treatment of a subsequent stage in a copper electrode formation process P1 of FIG. 5 is prepared first, and then copper electrode parts 9 are formed by printing or the like in the form of a stripe at the right and left ends of each chip component region 7 on the top and bottom surfaces of the chip component assembly 8. When the chip component 1D is a ceramic capacitor, the chip component assembly 8 is a substrate of unfired ceramic element assembly, and, after the formation of the electrode parts 9, the ceramic element assembly and the electrode parts 9 are actually co-fired. In order to perform the co-firing, the electrode parts 9 need to be copper or silver and, to the end, the electrode part 9 is formed with copper.

Next, a wax 12 is applied to the entire surface of the chip component assembly 8 by a wax application process P2 of FIG. 5 after forming, by plating or the like, copper layers 10 in the form of a stripe on the electrode parts 9 on the front surface of the chip component assembly 8. In order to achieve excellent laser reflection, the copper layers 10 are formed covering the electrode parts 9 so as to increase the copper thickness as much as possible.

Next, by a groove formation process P3 of FIG. 5, the chip component assembly 8 to which the wax 12 has been applied is placed on an adhesive dicer sheet 13, and then stripe-like grooves 14 along the boundaries (dashed lines of FIG. 5) at the end surface of each chip component region 7 of the chip component assembly 8 are formed by a dicer cut. In this case, the chip component assembly 8 maintains a unified state due to the adhesiveness of the dicer sheet 13.

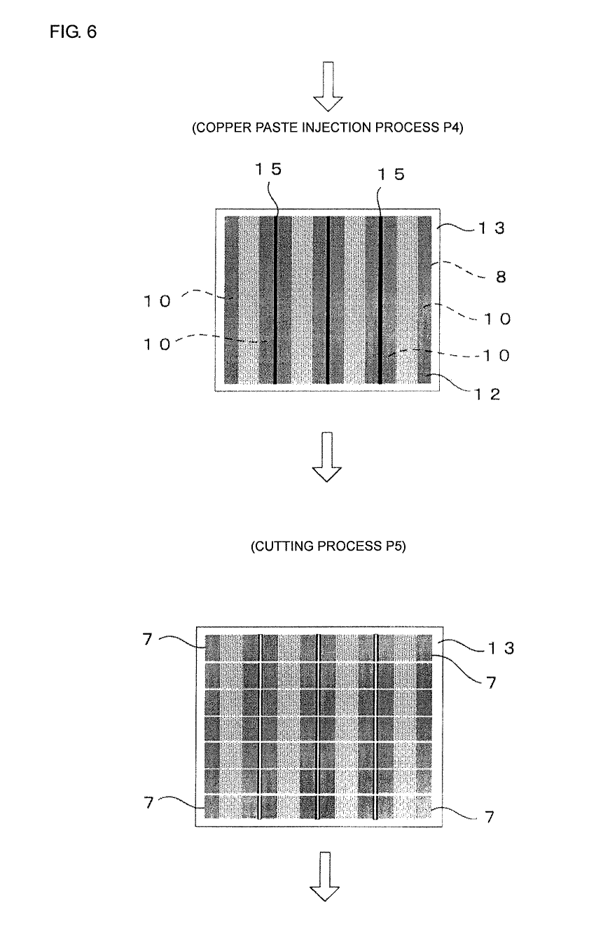

Next, by a copper paste injection process P4 of FIG. 6, each groove 14 is charged with a copper paste 15, the copper paste is cured, and the electrode parts 9 of both surfaces of the chip component assembly 8 are bonded to each other with the copper paste 15, thereby forming electrode parts at the right and left ends of each chip component region 7.

Then, the process proceeds to a cutting process P5 of FIG. 6 in which the chip component assembly 8 is cut in all directions by a dicer cut whose width is smaller than that of the groove formation process P3, and divided into each chip component region 7. In this case, as enlargedly shown in FIG. 8A and FIG. 8B, each divided chip component region 7 has a chip component element assembly 11a formed by the substrate of the chip component assembly 8, divided electrode parts 9a formed by vertically cutting the electrode parts 9 are provided on both surfaces of the right and left ends, and the end surfaces are covered with end surface electrode parts 15a formed by curing of the copper paste 15. Divided copper layers 10a formed by cutting the copper layer 10 are disposed on the divided electrode parts 9a on the top surface, whereby the copper electrode parts 37 shown in FIG. 8B are formed to have two layers of the divided electrode parts 9a on the top surface and the divided copper layers 10a.

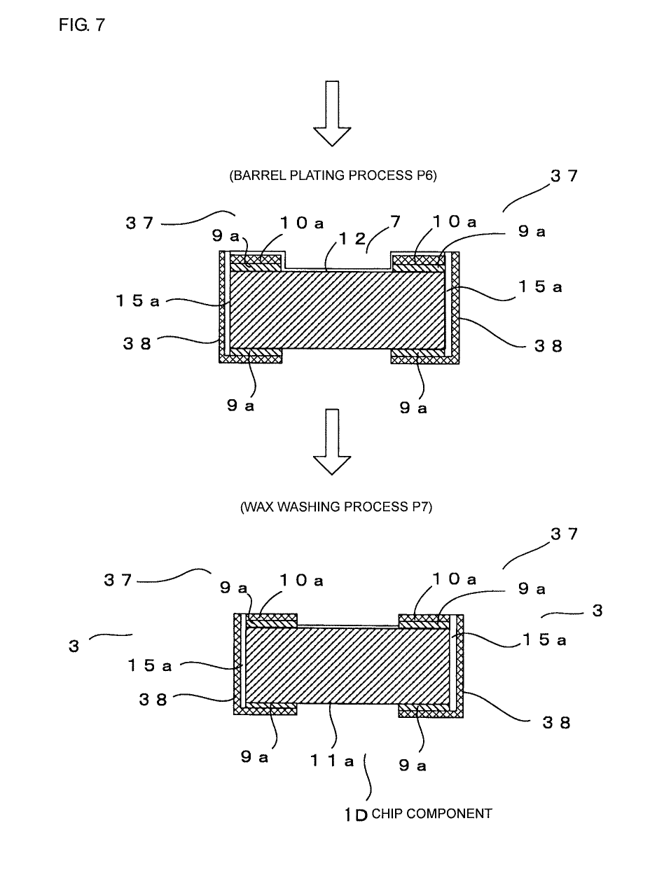

Next, the process proceeds to a barrel plating process P6 of FIG. 7 in which portions at the right and left ends of each chip component region 7 that are not covered with the wax 12, i.e., the remaining portion other than the top surface, are plated with tin or nickel to form electrode parts 38 thereof.

Then, the wax 12 of the right and left ends of each chip component region 7 are removed by washing by a wax washing process P7 of FIG. 7, and thus the chip component 1D is mass-produced.

In the external electrodes 3 at the right and left ends of the chip component 1D, the top surface is constituted by the copper electrode part 37 and the front surface of the remaining portion is constituted by the tin or nickel electrode part 38. Therefore, the mass-produced chip components 1D demonstrate the same effects as those of the chip components 1A to 1C of the first to third embodiments. The electrode part 37 on the top surface of the external electrodes 3 is formed in such a manner as to be thick. Thus, for example, when the chip component 1D is built into the component built-in module 2 of FIG. 2 and the top surface of the chip component 1D is irradiated with a laser from above of the insulating layer 4 to form the via hole conductor 5 as the interlayer connection conductor, there is an advantage in that the external electrodes 3 of chip component 1D are more difficult to be affected by a laser.

Then, according to the production method of this embodiment, the chip components 1A to 1C also can be similarly mass-produced.

### <Component Built-In Module and a Method for Producing the Same>

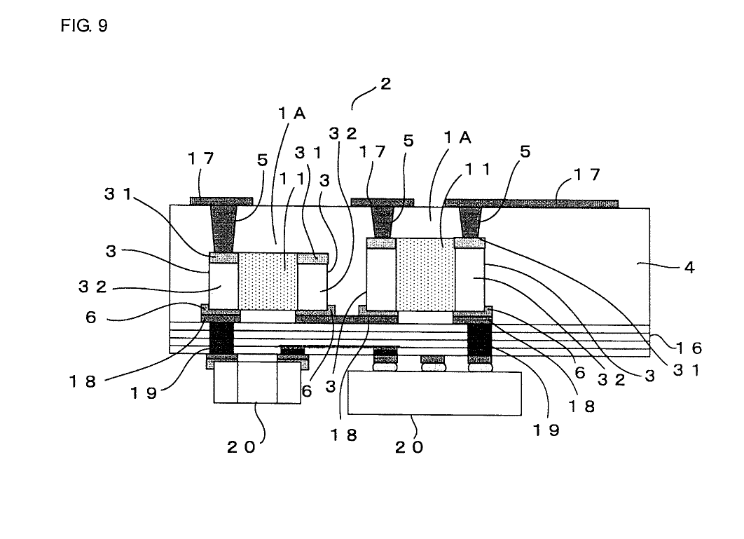

Next, embodiments of the component built-in module according to preferred embodiments of the invention and a method for producing the same will be described with reference to FIGS. 9 to 12.

### Fifth Embodiment

Next, the component built-in module 2 of this embodiment corresponding to Aspects 5 to 7 will be described with reference to the cross sectional view of FIG. 9. FIG. 9 illustrates the entire structure of the component built-in module 2 virtually illustrated in FIG. 2 in an upside down manner in order to be in consistency with FIG. 2 and other figures.

As shown in FIG. 9, the component built-in module 2 roughly contains the insulating layer 4 and a four-layered substrate 16 serving as a base. The insulating layer 4 is formed of, for example, a thermosetting insulating resin, contains one or a plurality of the chip components 1A, and have, for example, electrodes 17 and 18 of a conductor pattern (circuit pattern) formed as the in-plane conductor on one principal surface (top surface) of the insulating layer 4 on the upper side of FIG. 9 and the in-plane conductor on the other principal surface (bottom surface) of the insulating layer on the lower side of FIG. 9, respectively.

The component built-in module 2 is different from a former module in that, in order to reduce the height and size, at least one portion of one principal surface of the insulating layer 4 in each external electrode 3 at the right and left ends of each chip component 1A to be built into the insulating layer 4 is formed of a metal different from a metal forming the remaining portion, and the external electrodes 3 are utilized for connection between the electrodes 17 and 18.

More specifically, in the component built-in module 2, since the external electrodes 3 of the chip component 1A are apart from the electrodes 17 on one principal surface of the insulating layer 4, the external electrodes 3 and the electrodes 17 are connected through the interlayer connection conductor, such as the via hole conductor or the through hole conductor. In order to favorably form a hole of the via hole conductor or the through hole conductor in the insulating layer 4 with a laser, the electrode parts 31 of the external electrodes 3 are formed of copper. In order to reduce the height and size of the component built-in module 2 by connecting the external electrodes 3 and the electrodes 18 on the other principal surface with the solder 6 serving as the electrically conductive bonding material, at least the front surface of the electrode parts 32 of the remaining portion of the external electrodes 3 are formed of tin or nickel suitable for soldering.

Then, the copper electrode parts 31 of the external electrodes 3 are connected to the electrodes 17 on the top surface of the insulating layer 4 through the via hole conductor 5 serving as the interlayer connection conductor, and the tin or nickel electrode parts 32 of the external electrodes 3 are connected to the electrodes 18 on the bottom surface of the insulating layer 4 with the solder 6.

In this case, although the external electrodes 3 and the electrodes 17 on the top surface of the insulating layer 4 are connected through the via hole conductor 5 having a certain height, the external electrodes 3 and the electrodes 18 on the bottom surface of the insulating layer 14 are connected with the solder 6 to achieve a thin electrode structure suitable for the reduction in the height. Moreover, it is not necessary to provide another interlayer connection conductor through which the electrodes 17 and 18 are connected to the insulating layer 4, and thus the component built-in module 2 whose height and size are reduced, which has not hitherto been achieved, can be provided.

Moreover, in the component built-in module 2, the line length between the top and bottom surfaces of the insulating layer 4 does not become long, electrical loss does not increase, the number of the interlayer connection conductors in the insulating layer 4 does not increase, and the wiring density does not increase. Therefore, mutual interference between interlayer connection conductors or the like does not occur.

Furthermore, since the electrode parts 31 of chip component 1A are formed of copper, there is also an advantage in that the via hole conductor 5 can be formed without injury or the like to the chip component 1A by irradiating the insulating layer 4 with a laser.

The electrodes 18 of FIG. 9 are connected to each mounting component 20 on the front surface of the substrate 16 via through hole conductors 19 penetrating the substrate 16, for example.

Also when the chip components 1B to 1D in place of the chip component 1A are built into the insulating layer 4, a component built-in module demonstrating the same effects can be formed and provided.

### Sixth Embodiment

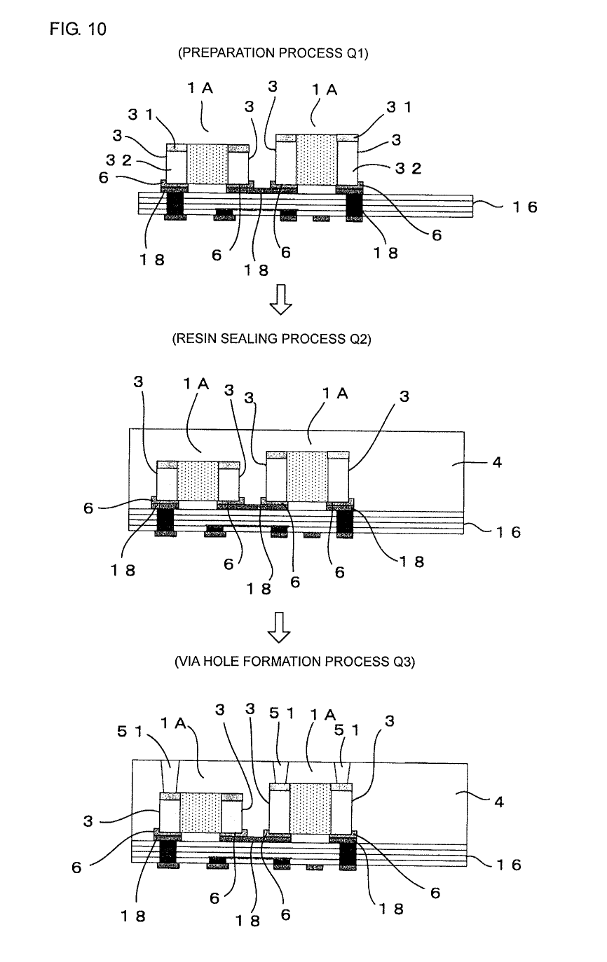

Next, a method for producing the component built-in module 2 corresponding to Aspects 8 to 11 will be described with reference to FIGS. 10 to 12.

First, the substrate (base) 16 having the electrodes 18 formed on the top surface and a required number of the chip components are prepared by a preparation process Q1 of FIG. 10. Then, the chip components 1A are arranged on the substrate 16 with the copper electrode parts 31 of the external electrodes 3 at the right and left ends up, the tin or nickel of the electrode parts 32 of the external electrodes 3 of the chip component 1A are solder mounted to the electrodes 18 of the substrate 16 for bonding.

Next, the process proceeds to a resin sealing process Q2 of FIG. 10 in which a prepreg of insulating resin is pressed against the substrate 16 from above, and forming the insulating layer 4 by, for example, heat curing the same, whereby each chip component 1A is sealed and embedded in the insulating layer 4.

Next, by a via hole making process Q3 of FIG. 10, the top surfaces of the electrode parts 31 of the external electrodes 3 of chip component 1A are irradiated with a laser from above of the insulating layer 4 to form via holes 51 in the insulating layer 4.

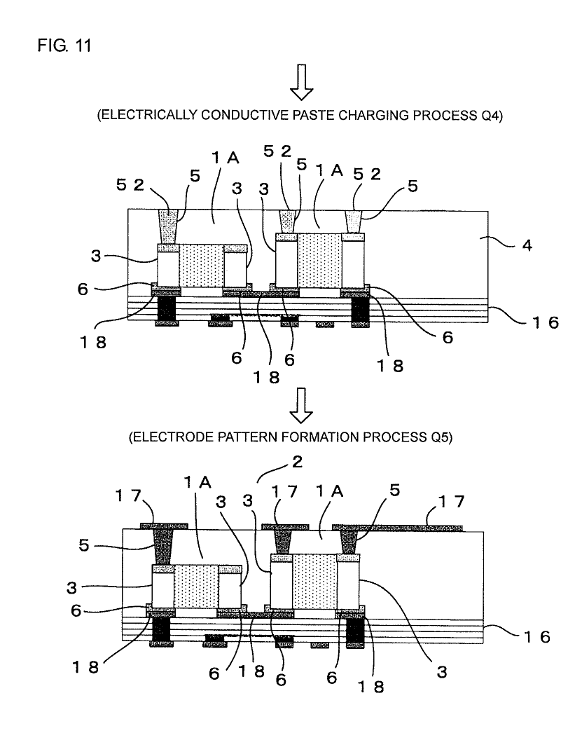

Furthermore, the process proceeds to an electrically conductive paste charging process Q4 of FIG. 11 in which the via holes 51 are charged with an electrically conductive paste 52 to form the via hole conductors 5 serving as the interlayer connection conductor.

Then, by an electrode pattern formation process Q5 of FIG. 11, conductor patterns of the electrodes 17 are formed on the top surface of the insulating layer 4 covering each via hole conductor 5, thereby producing the component built-in module 2.

In this case, the chip component 1A is built into the insulating layer 4, the external electrodes 3 of chip component 1A and the electrodes 18 of the insulating layer 4 are connected by solder mounting, and the external electrodes 3 of the chip component 1A and the electrodes 17 of the insulating layer 4 are interlayer-connected to each other via the hole conductors 5, whereby the component built-in module 2 whose height and size are reduced compared with the related art can be easily produced. Since the electrode parts 32 of the external electrodes 3 of the chip component 1A are tin or nickel, solder mounting between the external electrodes 3 of the chip component 1A and the electrodes 18 of the insulating layer 4 can be favorably performed. Furthermore, since the electrode parts 31 of the external electrodes 3 of the chip component 1A are copper with favorable laser reflection, there is also an advantage in that the via hole conductors 5 serving as the interlayer connection conductor are favorably formed by laser irradiation without injury to the external electrodes 3.

Therefore, the component built-in module 2 having a reduced size and high quality which has not hitherto been achieved can be produced and provided.

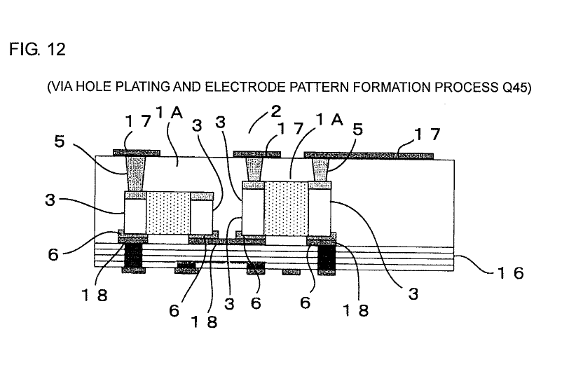

The component built-in module 2 can be produced by, after the via hole making process Q3 of FIG. 10, plating the top surface of the insulating layer 4 with copper to fill each via hole 51 with the copper and forming the conductor pattern of the electrodes 17 by a via hole plating and electrode pattern formation process Q45 of FIG. 12 in place of the electrically conductive paste charging process Q4 and the electrode pattern formation process Q5 of FIG. 11. When the via holes 51 are not filled up with the copper plating when the diameter is large, only the wall surfaces of the via holes 51 are plated with copper and the inside thereof may be charged with an electrically conductive paste or a non-conductive paste.

Also when the chip components 1B to 1D are used in place of the chip component 1A, the component built-in module can be easily produced similarly.

While preferred embodiments of the invention have been described above, it is to be understood that variations and modifications will be apparent to those skilled in the art without departing from the scope and spirit of the invention. The scope of the invention, therefore, is to be determined solely by the following claims. For example, it is a matter of course that, in the component built-in module 2, the interlayer connection conductor may be a through hole conductor or the like. The substrate (base) 16 of the component built-in module 2 may be a ceramic substrate, a resin substrate, a multi-layered substrate thereof, a stainless steel or PET transfer plate, or the like. Any material may be used for the insulating-layer 4 and the dimensions and the like of the chip components 1A to 1D and the component built-in module 2 may not be limited.

The invention can be applied to various chip components and methods for producing the same and component built-in modules and methods for producing the same.

What is claimed is:

1. A chip component, comprising:
a chip element assembly;
at least one external electrode at one end of the chip element assembly,
at least one portion of the at least one external electrode on one principal surface of the chip element assembly is composed of a first metal different from a second metal composing a remaining portion of the at least one external electrode.

2. The chip component according to claim 1, wherein the at least one portion of the external electrode is composed of copper and at least a surface of the remaining portion of the at least one external electrode is composed of tin or nickel.

3. The chip component according to claim 1, wherein external electrodes are at each end of the chip element assembly.

4. The chip component according to claim 1, wherein only the central portion of the at least one external electrode on the one principal surface of the chip element assembly is composed of the first metal.

5. A method for producing a chip component, the method comprising:
forming copper electrode parts on at least one portion of one principal surface of each end of a chip element assembly; and
forming electrode parts, composed of at least tin or nickel, on a remaining portion of each end of the chip component assembly.

6. A method for producing a chip component that has external electrodes at ends thereof and is built into an insulating layer of a component built-in module, the method comprising:
preparing a substantially substrate-like chip component assembly that is divided into a plurality of chip component regions and forming copper electrode parts at respective ends of each chip component region on opposed surfaces of the chip component assembly;
forming, in the chip component assembly, grooves along a boundary between the ends of each chip component region;
charging the grooves with a copper paste, and bonding the copper electrode parts of the opposed surfaces of each chip component region with the copper paste;
cutting and dividing the chip component assembly in which the grooves are charged with the copper paste into each chip component region; and
plating a portion other than at least one portion of the top surface or the bottom surface at the ends of each divided chip component region with tin or nickel to form the external electrodes.

7. A component built-in module comprising:
an insulating layer;
the chip component according to claim 1 built into the insulating layer;
an interlayer connection conductor through which the at least one portion of the at least one external electrode is connected to a first in-plane conductor on a first surface of the insulating layer; and
an electrically conductive bonding material through which the remaining portion of the at least one external electrode is bonded to a second in-plane conductor on a second surface of the insulating layer.

8. The component built-in module according to claim 7, wherein
the at least one portion of the at least one external electrode is composed of copper; and
the interlayer connection conductor is formed by imparting electrical conductivity to a hole formed by irradiating the insulating layer with a laser.

9. The component built-in module according to claim 6, wherein
at least part of the remaining portion of the external electrode is composed of tin or nickel; and
the electrically conductive bonding material is a solder.

10. A method for producing a component built-in module containing a chip component having external electrodes at ends thereof in an insulating layer,
the chip component having at least one portion of one principal surface of the external electrodes formed of a metal different from that of a remaining portion of the external electrodes,
the method comprising:
connecting the at least one portion of the one principal surface of the external electrodes to an in-plane conductor on a first principal surface of the insulating layer through an interlayer connection conductor; and
bonding the remaining portion of the external electrodes to an in-plane conductor on a second principal surface of the insulating layer with an electrically conductive bonding material.

11. A method for producing a component built-in module containing a chip component having external electrodes at ends thereof in an insulating layer,
in the chip component, at least one portion of the external electrodes formed of a metal different from that of a remaining portion of the external electrodes, the method comprising:
preparing a base having an in-plane conductor formed on a top surface thereof and bonding the remaining portion of the external electrodes to the in-plane conductor of the base with an electrically conductive bonding material;
embedding the chip component in the insulating layer; and
forming, in the insulating layer, an interlayer connection conductor at a location for connection to the at least one portion of the external electrodes.

12. The method for producing a component built-in module according to claim 11, wherein
in the remaining portion of the external electrodes, at least a surface to be bonded to the electrically conductive bonding material is formed of tin or nickel; and
the electrically conductive bonding material is a solder.

13. The method for producing a component built-in module according to claim 12, wherein
the at least one portion of the external electrodes is composed of copper; and
the interlayer connection conductor is formed by imparting electrical conductivity to a hole formed by irradiating the insulating layer with a laser.
